(19) United States
(12) Patent Application Publication
(10) Pub. No.: US 2007/0274863 A1
(43) Pub. Date: Nov. 29, 2007

(54) Fluidic circuits for sample preparation including bio-discs and methods relating thereto

(76) Inventors: Horacio Kido, Niland, CA (US); James R. Norton, Santa Ana, CA (US); James H. Coombs, Nassim Park (SG)

Correspondence Address: KNOBBE MARTENS OLSON & BEAR LLP, 2040 MAIN STREET, FOURTEENTH FLOOR, IRVINE, CA, 92614, US

(21) Appl. No.: 10/565,698

(22) PCT Filed: Jul. 22, 2004
(86) PCT No.: PCT/US04/23891

§ 371 Date: Dec. 15, 2006

(30) Foreign Application Priority Data
Jul. 25, 2003 (US) 60489978

(51) Int. Cl. B01L 11/00

(52) U.S. Cl. 422/68.1

(57) ABSTRACT

A fluidic circuit for receiving a fluid and separating a component of a fluid from the fluid comprises a separation chamber for receiving the fluid, an air chamber in fluid communication with the separation chamber, and return channel in fluid communication with the separation chamber. In an advantageous embodiment, the fluidic circuit is subjected to a force, such as a centrifugal force, so that substantially all of the component of the fluid is moved to the return channel while substantially all remaining portions of the fluid are moved tot the separation chamber.

### BACKGROUND OF THE INVENTION

1. Field of the Invention

This invention relates in general to optical discs, optical disc drives and optical disc interrogation methods and, in particular, to sample preparation in optical discs. More specifically, this invention relates to optical discs including fluidic circuits with rotationally controlled liquid valves.

2. Description of the Related Art

The Optical Bio-Disc, also referred to as Bio-Compact Disc (BCD), bio-optical disc, optical analysis disc or compact bio-disc, is known in the art for performing various types of bio-chemical analyses. In particular, an optical disc may utilize a laser source of an optical storage device to detect biochemical reactions on or neat the operating surface of the disc itself. These reactions may be occurring in small channels inside the disc or may be reactions occurring on the open surface of the disc. Whatever the system, multiple reaction sites may be used to either simultaneously detect different reactions or to repeat the same reaction for error detection purposes.

### SUMMARY OF CERTAIN EMBODIMENTS OF THE INVENTION

In one embodiment, the invention is directed to optical discs including fluidic circuits with rotationally controlled liquid valves which may be used independently or in combination with air chambers for pneumatic fluid displacement used for sample isolation, and to related disc drive systems and methods.

In an exemplary embodiment, the invention is directed to an optical analysis bio-disc. The disc may advantageously include a substrate having an inner perimeter and an outer perimeter; an operational layer associated with the substrate and including encoded information located along information tracks; and an analysis area including investigational features. In this embodiment, the analysis area is positioned between the inner perimeter and the outer perimeter and is directed along the information tracks so that when an incident beam of electromagnetic energy tracks along them, the investigational features within the analysis area are thereby interrogated circumferentially.

In another embodiment, the invention is directed to an optical analysis disc as defined above, wherein when an incident beam of electromagnetic energy tracks along the information tracks, the investigational features within the analysis area are thereby interrogated according to a spiral path or, in general, according to a path of varying angular coordinate.

In an advantageous embodiment, the substrate includes a series of substantially circular information tracks that increase in circumference as a function of radius extending from the inner perimeter to the outer perimeter, the analysis area is circumferentially elongated between a pre-selected number of circular information tracks and the investigational features are interrogated substantially along the circular information tracks between a pre-selected inner and outer circumference.

In one embodiment, the analysis area includes a fluid chamber. Preferably, rotation of the bio-disc distributes investigational features in a substantially consistent distribution along the analysis area and/or in a substantially even distribution along the analysis area.

The invention is further directed to an optical analysis bio-disc. In this embodiment, the bio-disc includes a substrate having an inner perimeter and an outer perimeter; and an analysis zone including investigational features, the analysis zone being positioned between the inner perimeter and the outer perimeter of the substrate and extending according to a varying angular coordinate, and preferably according to a substantially circumferential or spiral path.

Preferably, the analysis zone extends according to a varying angular and radial coordinate. In an alternative embodiment, the analysis zone extends according to a varying angular coordinate and at a substantially fixed radial coordinate.

In one embodiment, the disc comprises an operational layer associated with the substrate and including encoded information located substantially along information tracks.

According to another embodiment, the substrate includes a series of information tracks, preferably of a substantially circular profile and increasing in circumference as a function of radius extending from the inner perimeter to the outer perimeter, and the analysis zone is directed substantially along the information tracks, so that when an incident beam of electromagnetic energy tracks along the information tracks, the investigational features within the analysis zone are thereby interrogated circumferentially. In one embodiment, the analysis zone is circumferentially elongated between a pre-selected number of circular information tracks, and the investigational features are interrogated substantially along the circular information tracks between a pre-selected inner and outer circumference.

In another embodiment, the analysis zone includes a plurality of reaction sites and/or a plurality of capture zones or target zones arranged according to a varying angular coordinate.

The optical analysis bio-disc may also include a plurality of analysis zones positioned between the inner perimeter and the outer perimeter of the substrate, at least one of which extends according to a varying angular coordinate.

Preferably, the analysis zones of the plurality extend according to a substantially circumferential path and are concentrically arranged around the-bio-disc inner perimeter.

In a variant embodiment, the disc includes multiple tiers of analysis zones, wherein each analysis zone extends according to a substantially circumferential path and each tier is arranged onto the bio-disc at a respective radial coordinate.

In a further preferred embodiment, the analysis zone includes one or more fluid chambers extending according to a varying angular coordinate, which chamber(s) has a central portion extending according to a varying angular coordinate and two lateral arm portions extending according to a radial direction.

Preferably, the chamber central portion has an angular extension θₐ being in a ratio θₐ/θ equal to or greater than 0.25 with the angle θ comprised between the chamber arm portions.

Furthermore, such embodiment may provide that the analysis zone includes at least a liquid-containing channel extending accordingly along a substantially circumferential path and the radius of curvature of the channel r_{c} and the length of the column of liquid b contained within the channel are in a ratio r_{c}/b equal to or greater than 0.5, and more preferably equal to or greater than 1.

Moreover, the optical analysis disc may include two inlet ports located at a lower radial coordinate of the bio-disc itself with respect to the analysis zone. Preferably, such ports are located each at one end of a respective lateral arm portion of the fluid chamber.

In a further preferred embodiment, the at least one fluid chamber is a fluid channel extending according to a varying angular coordinate.

In such embodiment, the disc may include multiple tiers of analysis fluid channels, eventually comprising different assays, blood types, concentrations of cultured cells and the like. A set of fluid channels can also be arranged at substantially the same radial coordinate. Furthermore, the fluid channels can have the same or different sizes.

The disc may be either a reflective-type or transmissive-type optical bio-disc. As in previous embodiments, preferably rotation of the bio-disc distributes investigational features in a substantially consistent and/or even distribution along the analysis zone.

According to another preferred embodiment, the optical analysis bio-disc may include a substrate having an inner perimeter and an outer perimeter; and an analysis zone including investigational features and positioned between the inner perimeter and the outer perimeter of the substrate. The analysis zone includes at least a liquid-containing channel having at least a portion which extends along a substantially circumferential path. The radius of curvature of the channel circumferential portion r_{c} and the length of the column of liquid b contained within the channel are preferably in a ratio r_{c}/b equal to or greater than 0.5. More Preferably, the ratio r_{c}/b is equal to or greater than 1. Also in this embodiment, the disc can be either a reflective-type or a transmissive-type optical bio-disc.

The invention is also directed to an optical analysis bio-disc system for use with an optical analysis bio-disc as defined so far, which system includes interrogation devices of the investigational features adapted to interrogate the latter according to a varying angular coordinate.

Such interrogation devices may be such that when an incident beam of electromagnetic energy tracks along disc information tracks, any investigational features within the analysis zone are thereby interrogated circumferentially.

Preferably, the interrogation devices are adapted to interrogate the investigational features according to a varying angular coordinate at a substantially fixed radial coordinate or, alternatively, according to a varying angular and radial coordinate.

More preferably, the interrogation devices are employed to interrogate the investigational features according to a spiral or a substantially circumferential path.

According to a further preferred embodiment, the interrogation devices are utilized to interrogate investigational features at a plurality of reaction sites or capture or target zones arranged according to a varying angular coordinate.

The invention is also directed to a method for the interrogation of investigational features within an optical analysis bio-disc as defined so far. This method provides interrogation of the investigational features according to a varying angular coordinate, and preferably according to a spiral or a substantially circumferential path.

Such interrogation step may also be such that when an incident beam of electromagnetic energy tracks along disc information tracks, any investigational features within the analysis zone are thereby interrogated circumferentially.

Preferably, the interrogation step provides interrogation of the investigational features according to a varying angular coordinate at a substantially fixed radial coordinate or, alternatively, according to a varying angular and radial coordinate.

According to a further preferred embodiment, the interrogation step provides interrogation of investigational features at a plurality of similar or different, reaction sites, capture zones, or target zones arranged according to a varying angular coordinate.

This invention or different aspects thereof may be readily implemented in or adapted to many of the discs, assays, and systems disclosed in the prior art.

The above described methods and apparatus according to the invention as disclosed herein can have one or more advantages which include, but are not limited to, simple and quick on-disc processing without the necessity of an experienced technician to run the test, small sample volumes, use of inexpensive materials, and use of known optical disc formats and drive manufacturing. These and other features and advantages will be better understood by reference to the following detailed description when taken in conjunction with the accompanying drawing figures and technical examples.

### BRIEF DESCRIPTION OF THE DRAWINGS

Further objects of the invention, together with additional features contributing thereto, and advantages accruing therefrom will be apparent from the following, description of the certain embodiments of the invention which are shown in the accompanying drawing figures with like reference numerals indicating like components throughout, wherein:

FIG. 1 is a pictorial representation of a bio-disc system;

FIG. 2 is:an exploded perspective view of a reflective bio-disc;

FIG. 3 is a top plan view of the disc shown in FIG. 2;

FIG. 4 is a perspective view of the disc illustrated in FIG. 2 with cut-away sections showing the different layers of the disc;

FIG. 5A is an exploded perspective view of a transmissive bio-disc;

FIG. 5B is a perspective view representing the disc shown in FIG. 5A with a cut-away section illustrating the functional aspects of a semi-reflective layer of the disc;

FIG. 6 is a perspective and block diagram representation illustrating the system of FIG. 1 in more detail;

FIG. 7 is a partial cross sectional view taken perpendicular to a radius of the reflective optical bio-disc illustrated in FIGS. 2, 3, and 4 showing a flow channel formed therein;

FIGS. 8A, 8B, 8C, and 8D are each a top view of a fluidic circuit configured to be placed on a bio-disc, wherein FIGS. 8B, 8C, and 8D are illustrative of steps in an assay process;

FIG. 9 is a top plan view of a bio-disc having fluidic circuits with a liquid valve for separating samples, wherein certain of the fluidic circuits illustrate movement of material in the fluidic circuit during an assay process;

FIGS. 10A, 10B, 10C, and 10D are each a top view of a fluidic circuit with an air chamber for pneumatic fluid displacement, wherein FIGS. 10B, 10C, and 10D are illustrative of steps in separating samples using the fluidic circuit; and

FIGS. 11A, 11B, 11C, and 11D are each a top view of another embodiment of a fluid fluidic, wherein FIGS. 11B, 11C, and 11D are illustrative of steps for separating samples using the fluidic circuit.

FIG. 12 is an exploded perspective view of yet another embodiment of the bio-disc having a fluidic circuit for processing samples; and

FIG. 13 is a top plan view of the disc of FIG. 12 showing various embodiments of the fluidic circuit.

### DETAILED DESCRIPTION OF THE PREFERRED EMBODIMENT

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

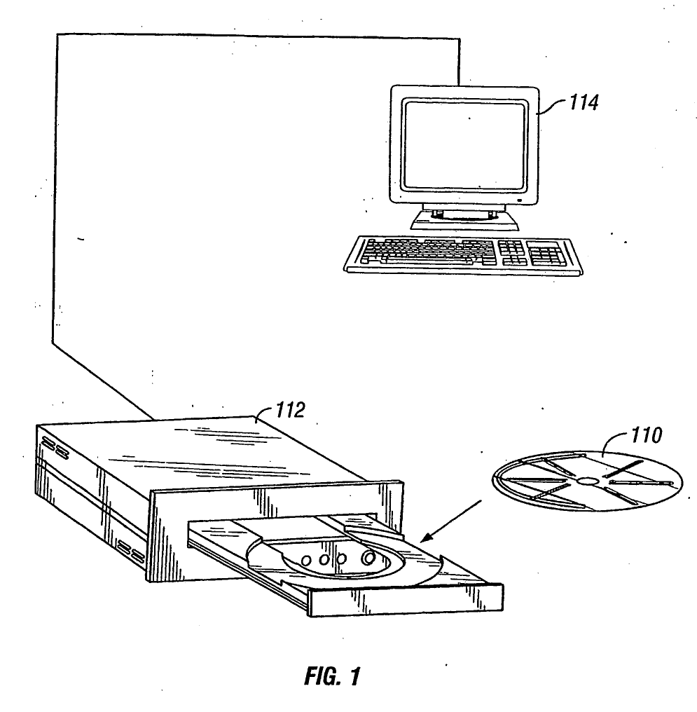

FIG. 1 is a perspective view of an optical bio-disc 110 for conducting biochemical analyses, and in particular cell counts and differential cell counts. The present optical bio-disc 110 is shown in conjunction with an optical disc drive 112 and a display monitor 114.

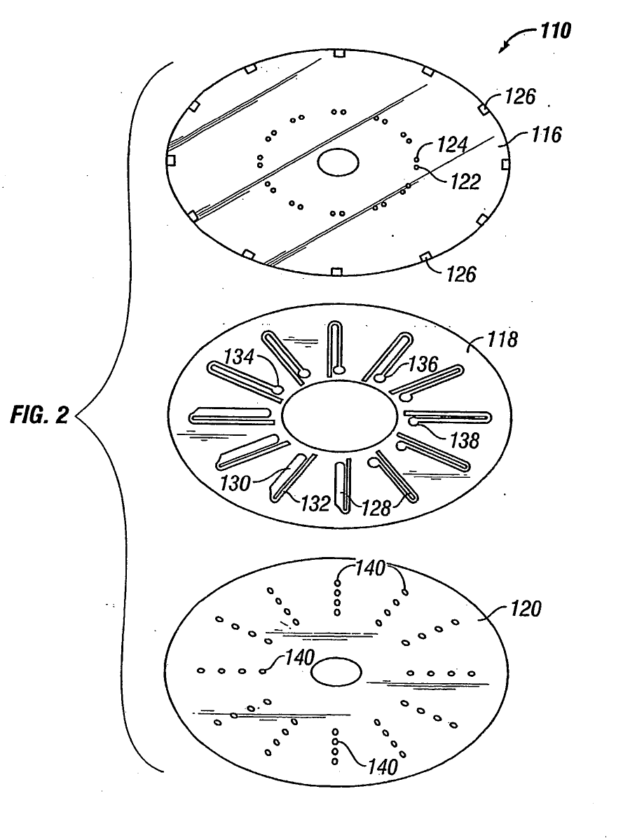

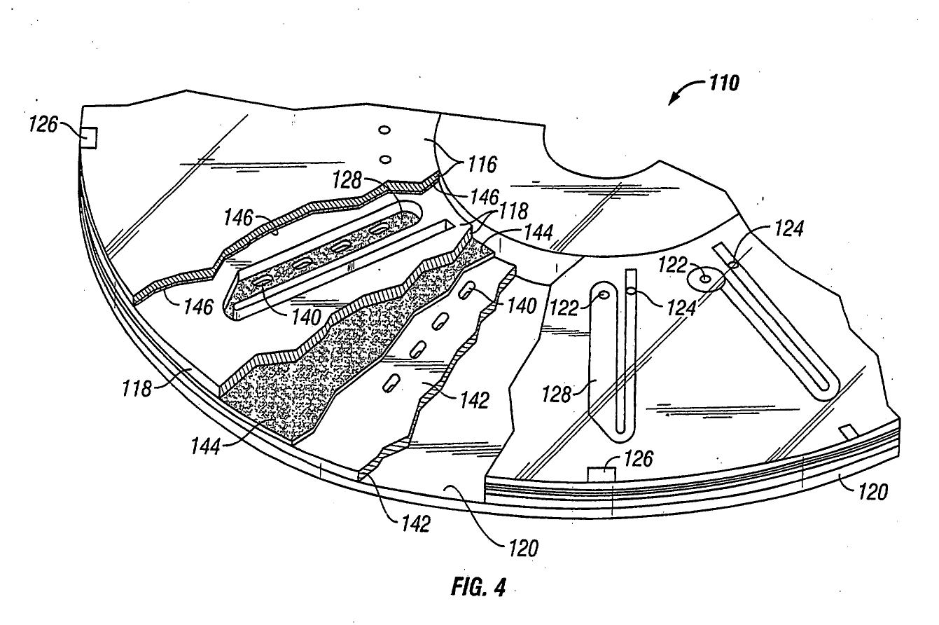

FIG. 2 is an exploded perspective view of the principal structural elements of one embodiment of the optical bio-disc 110. FIG. 2 is an example of a reflective zone optical bio-disc 110 (hereinafter “reflective disc”) that may be used in conjunction with the systems and methods described herein. The optical bio-disc 110 includes a cap portion 116, an adhesive member or channel layer 118, and a substrate 120. In the embodiment of FIG. 2, the cap portion 116 includes one or more inlet ports 122 and one or more vent ports 124. The cap portion 116 may be formed from polycarbonate and is preferably coated with a reflective surface 146 (shown in FIG. 4) on the bottom thereof as viewed from the perspective of FIG. 2. In one embodiment, trigger marks or markings 126 are included on the surface of a reflective layer 142 (shown in FIG. 4). Trigger markings 126 may include a clear window in all three layers of the bio-disc, an opaque area, or a reflective or semi-reflective area encoded with information that sends data to a processor 166, which in turn interacts with the operative functions of an interrogation or incident beam.

In the embodiment of FIG. 2, the adhesive member or channel layer 118 includes fluidic circuits 128 or U-channels formed therein. The fluidic circuits 128 may be formed by stamping or cutting the membrane to remove plastic film and form the shapes as indicated. Each of the fluidic circuits 128 includes a flow channel or analysis zone 130 and a return channel 132. Some of the fluidic circuits 128 illustrated in FIG. 2 include a mixing chamber 134. Two different types of mixing chambers 134 are illustrated. The first is a symmetric mixing chamber 136 that is symmetrically formed relative to the flow channel 130. The second is an off-set mixing chamber 138. The off-set mixing chamber 138 is formed to one side of the flow channel 130 as indicated.

In the embodiment of FIG. 2, the substrate 120 includes target or capture zones 140. In an advantageous embodiment, the substrate 120 is made of polycarbonate and has the aforementioned reflective layer 142 deposited on the top thereof (shown in FIG. 4). The target zones 140 may be formed by removing the reflective layer 142 in the indicated shape or alternatively in any desired shape. Alternatively, the target zone 140 may be formed by a masking technique that includes masking the target zone 140 area before applying the reflective layer 142. The reflective layer 142 may be formed from a metal such as aluminum or gold.

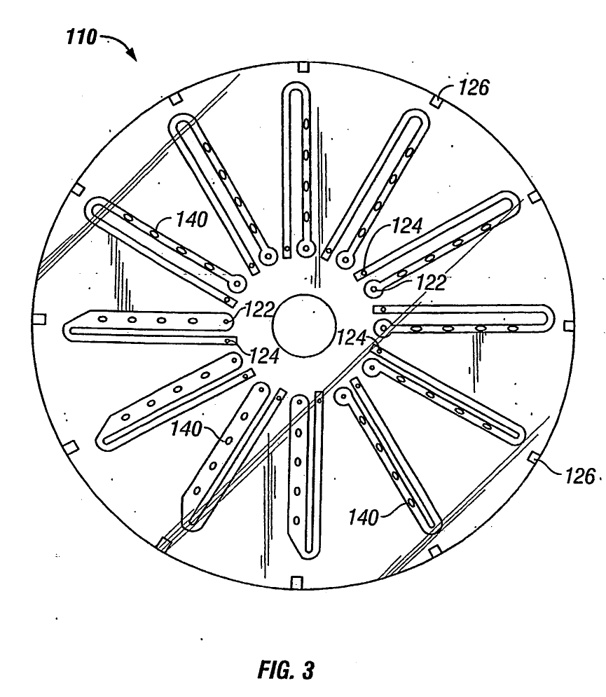

FIG. 3 is a top plan view of the optical bio-disc 110 illustrated in FIG. 2 with the reflective layer 146 on the cap portion 116 shown as transparent to reveal the fluidic circuits 128, the target zones 140, and trigger markings 126 situated within the disc.

FIG. 4 is an enlarged perspective view of the reflective zone type optical bio-disc 110 according to one embodiment. FIG. 4 illustrates a portion of the various layers of the optical bio-disc 110 cut away to illustrate a partial sectional view of several layers. In particular, FIG. 4 illustrates the substrate 120 coated with the reflective layer 142. An active layer 144 is applied over the reflective layer 142. In an advantageous embodiment, the active layer 144 may be formed from polystyrene. Alternatively, polycarbonate, gold, activated glass, modified glass, or modified polystyrene, for example, polystyrene-co-maleic anhydride, may be used. In addition, hydrogels can be used. Alternatively, as illustrated in this-embodiment, the plastic adhesive member 118 is applied over the active layer 144. The exposed section of the plastic adhesive member 118 illustrates the cut out or stamped U-shaped form that creates the fluidic circuits 128. The final principal structural layer in this reflective zone embodiment of the present bio-disc is the cap portion 116. In the embodiment of FIG. 4, the cap portion 116 includes the reflective surface 146 on the bottom thereof. The reflective surface 146 may be made from a metal such as aluminum or gold.

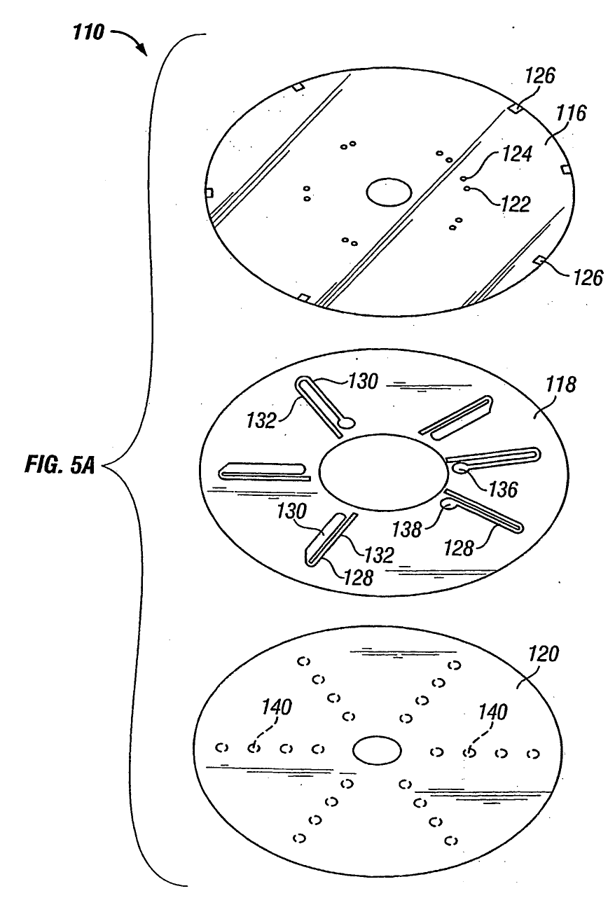

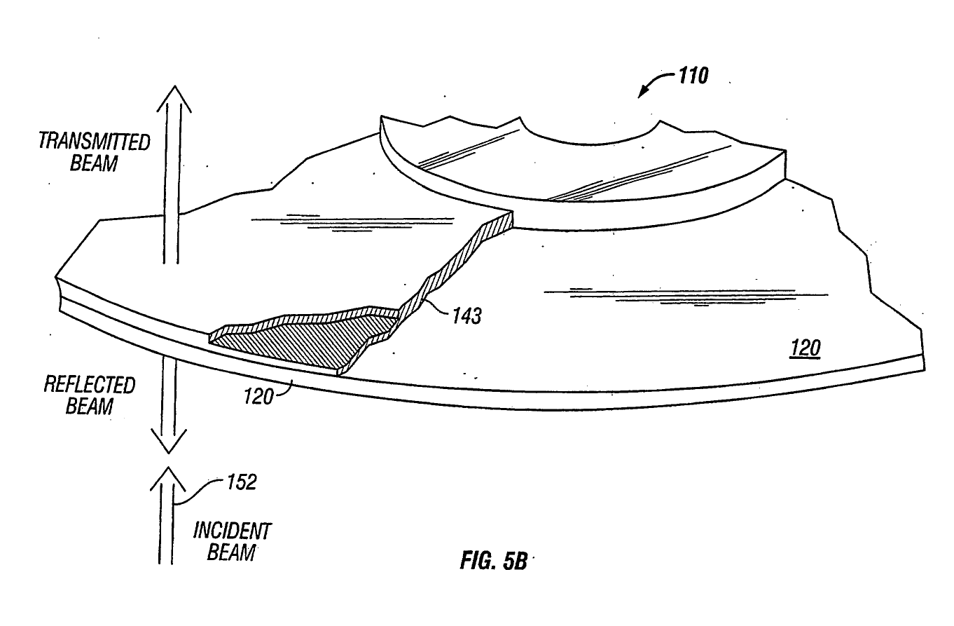

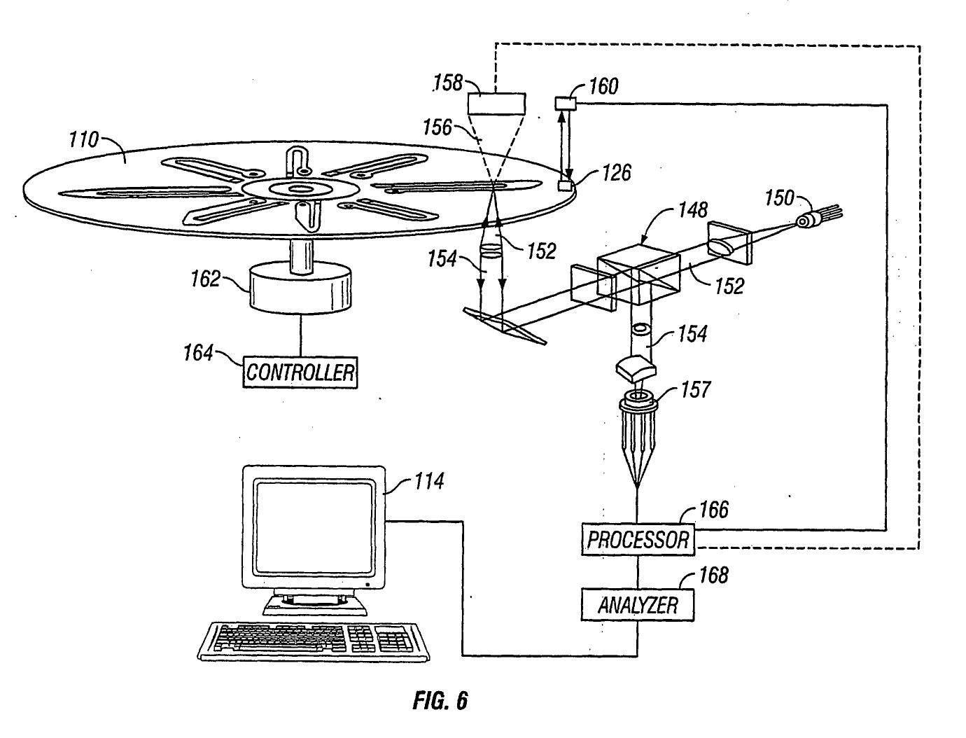

FIG. 5A is an exploded perspective view of certain elements of a transmissive type optical bio-disc 110, including the cap portion 116, the adhesive or channel member 118, and the substrate 120 layer. In this embodiment, the cap portion 116 includes one or more inlet ports 122 and one or more vent ports 124. The cap portion 116 may be formed from a polycarbonate layer. Optional trigger markings 126 may be included on the surface of a thin semi-reflective layer 143. Trigger markings 126 may include a clear window in all three layers of the bio-disc, an opaque area, or a reflective or semi-reflective area encoded with information that sends data to a processor 166 (FIG. 6), which in turn interacts with the operative functions of an interrogation beam 152.

The adhesive member or channel layer 118 is illustrated including fluidic circuits 128 or U-channels formed therein. The fluidic circuits 128 may be formed by stamping or cutting the membrane to remove plastic film and form the shapes as indicated. In the embodiment of FIG. 5A, each of the fluidic circuits 128 includes the flow channel 130 and the return channel 132. Some of the fluidic circuits 128 illustrated in FIG. 5A include a mixing chamber 134, such as those described above with respect to FIG. 2.

The substrate 120 may include target or capture zones 140. In one embodiment, the substrate 120 is made of polycarbonate and has the aforementioned thin semi-reflective layer 143 deposited on the top thereof, FIG. 5B. The semi-reflective layer 143 associated with the substrate 120 of the disc 110 illustrated in FIGS. 5A and 5B may be significantly thinner than the reflective layer 142 on the substrate 120 of the reflective disc 110 illustrated in FIGS. 2, 3 and 4. The thinner semi-reflective layer 143 may allows for some transmission of the interrogation beam 152 through the structural layers of the transmissive disc as shown in FIG. 5B. The thin semi-reflective layer 143 may be formed from a metal such as aluminum or gold.

FIG. 5B is an enlarged partially cut away perspective view of a portion of the substrate 120 and semi-reflective layer 143 of the transmissive embodiment of the optical bio-disc 110 illustrated in FIG. 5A. The thin semi-reflective layer 143 may be made from a metal such as aluminum or gold. In an advantageous embodiment, the thin semi-reflective layer 143 of the transmissive disc illustrated in FIGS. 5A and 5B is approximately 100-300 Å thick and does not exceed 400 Å. This thinner semi-reflective layer 143 allows a portion of the incident or interrogation beam 152 to penetrate and pass through the semi-reflective layer 143 to be detected by a top detector 158 (FIG. 6), while some of the light is reflected or returned back along the incident path.

Referring now to FIG. 6, there is a representation in perspective and block diagram illustrating optical-components 148, a light source 150 that produces the incident or interrogation beam 152, a return beam 154, and a transmitted beam 156. In the case of the reflective bio-disc illustrated in FIG. 4, the return beam 154 is reflected from the reflective surface 146 of the cap portion 116 of the optical bio-disc 110. In this reflective embodiment of the present optical bio-disc 110, the return beam 154 is detected and analyzed for the presence of signal elements by a bottom detector 157. In the transmissive bio-disc format, on the other hand, the transmitted beam 156 is detected, by the aforementioned top detector 158, and is also analyzed for the presence of signal elements. In the transmissive embodiment, a photo detector may be used as top detector 158.

FIG. 6 also shows a hardware trigger mechanism that includes the trigger markings 126 on the disc and the aforementioned trigger detector 160. The hardware triggering mechanism is used in both reflective bio-discs (FIG. 4) and transmissive bio-discs (FIG. 5B). The triggering mechanism allows the processor 166 to collect data only when the interrogation beam 152 is on a respective target zone 140, e.g. at a predetermined reaction site. Furthermore, in the transmissive bio-disc system, a software trigger may also be used. The software trigger uses the bottom detector to signal the processor 166 to collect data as soon as the interrogation beam 152 hits the edge of a respective target zone 140. FIG. 6 further illustrates a drive motor 162 and a controller 164 for controlling the rotation of the optical bio-disc 110. FIG. 6 also shows the processor 166 and analyzer 168 implemented in the alternative for processing the return beam 154 and transmitted beam 156 associated with the transmissive optical bio-disc.

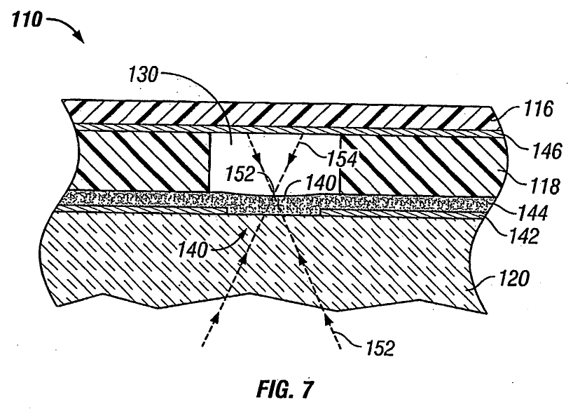

As shown in FIG. 7, there is presented a partial cross sectional view of the reflective disc embodiment of the optical bio-disc 110. FIG. 7 illustrates the substrate 120 and the reflective layer 142. As indicated above, the reflective layer 142 may be made from a material such as aluminum, gold or other suitable reflective material. In this embodiment, the top surface of the substrate 120 is smooth. FIG. 7 also shows the active layer 144 applied over the reflective layer 142. As also shown in FIG. 7, the target zone 140 is formed by removing an area or portion of the reflective layer 142 at a desired location or, alternatively, by masking the desired area prior to applying the reflective layer 142. As further illustrated in FIG. 7, the plastic adhesive member 118 is applied over the active layer 144. FIG. 7 also shows the cap portion 116 and the reflective surface 146 associated therewith. Thus when the cap portion 116 is applied to the plastic adhesive member 118 including the desired cutout shapes, flow channel 130 is thereby formed. As indicated by the arrowheads shown in FIG. 7, the path of the incident beam 152 is initially directed toward the substrate 120 from below the disc 110. The incident beam then focuses at a point proximate the reflective layer 142. Since this focusing takes place in the target zone 140 where a portion of the reflective layer 142 is absent, the incident continues along a path through the active layer 144 and into the flow channel 130. The incident beam 152 then continues upwardly traversing through the flow channel to eventually fall incident onto the reflective surface 146. At this point, the incident beam 152 is returned or reflected back along the incident path and thereby forms the return beam 154.

In many medical diagnostic applications it is helpful to centrifuge fluid samples in order to separate out one or more components contained therein, and then move or isolate each component into a separate chamber. For instance, it is frequently helpful to centrifuge out the blood cells from whole blood, and then isolate the serum into a separate chamber for analysis. It is advantageous that this separation and movement of liquid be performed within a fluidic circuit. In a fluidic circuit located in the bio-disc, centrifugal and capillary forces may be utilized in order to move fluids within the fluidic circuit. Certain assays may require mixing two or more reagents (often after previous centrifuging steps), which may advantageously be carried out on the bio-disc without external intervention.

One way of controlling fluid flow within fluidic circuits is the use of capillary valves, in which liquid stops at a certain narrowing or change in surface tension of a fluidic passage, and only centrifugation above a certain speed induces the liquid to cross this barrier. Described below are embodiments of an improved sample separation, isolation, and analysis apparatus or system and a method suitable for disc based diagnostic systems.

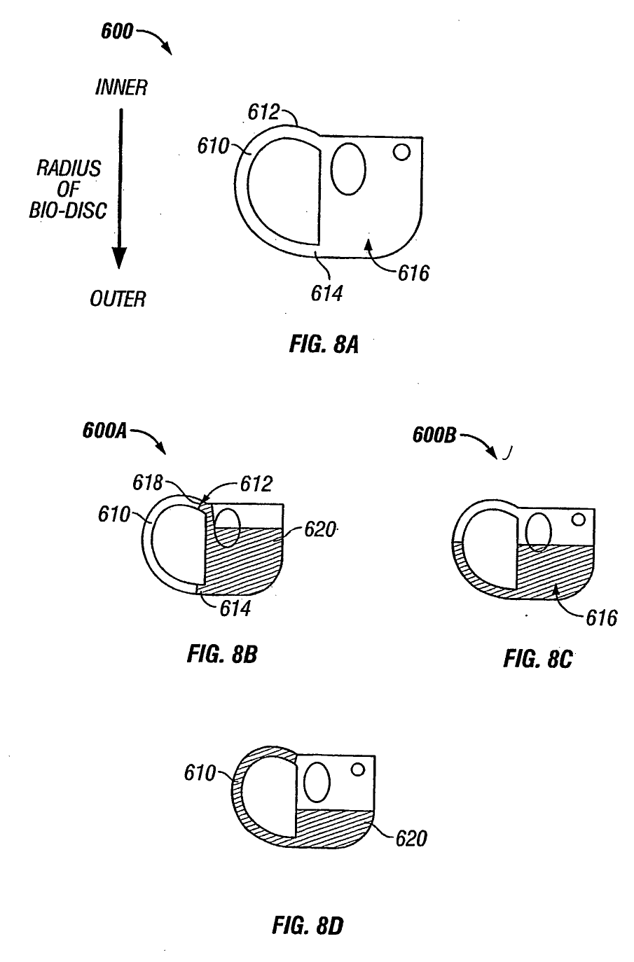

The various motive forces that may drive a liquid through a restricted channel or passage include, for example, centrifugal forces and capillary action. Systems and methods are desired for use of these forces in such a way that [1] liquid can be loaded or introduced through an entry or inlet port into a loading, mixing, or separation chamber, [2] the disc may be centrifuged in order to separate out unwanted particles, and [3] on cessation of centrifugation the liquid may be moved or isolated into a new chamber. FIGS. 8-11 each illustrate multiple fluidic circuits, where certain of the fluidic circuits illustrate the location of materials with the fluidic circuits at different steps in the sample preparation process and are denoted by [1], [2], or [3], which correspond to the above-listed sample preparation steps. In a typical symmetric fluidic circuit, on cessation of centrifugation the liquid will either remain still (State [2]), or move into the original configuration (State [1]), rather than moving into another or an adjacent channel (State [3]). Improved systems and methods which ensure that something changes during states [1] and/or [2] so that when centrifugation is stopped, State [3] is the most stable state, are described in detail below.

For a liquid to enter a channel by capillary forces, not only must the hydrophilicity of the channel be sufficiently high, but the air displaced by the liquid motion must be able to escape. If a channel is sealed or closed, capillary forces will draw liquid into the channel only until the air pressure in the channel rises to give an equal and opposite force.

FIGS. 8A, 8B, 8C, and 8D are each a top view of a fluidic circuit configured to be placed on a bio-disc, such as the bio-discs described with respect to the earlier Figures, wherein FIGS. 8B, 8C, and 8D are illustrative of steps in an assay process. In the embodiment of FIGS. 8A, 8B, 8C, and 8D, a return channel 610 is configured as a loop with a fluid exit portion 612 and a fluid entrance portion 614. The fluid exit portion 612 is at an inner radius of a rotatable substrate (not shown), while the entrance portion 614 is closer to the outer radius of the rotatable substrate. The fluidic circuits 600A (FIG. 8B), 600B (FIG. 8C), and 600C (FIG. 8D) each illustrate the position of materials within the fluidic circuit at various stages of separation of a component, such as serum, from a sample, such as whole blood. As illustrated in FIG. 8B, in state [1] (fluidic circuit 600A), a liquid 620 is introduced into the loading chamber 616 and is drawn into the exit portion 612 of the loop. However, the liquid 620 is prevented from entering the return channel 610 by a stopper 618, such as a capillary valve, a change in surface tension, a filter, or a hydrophobic coating, for example. The liquid 620 also flows into the entrance portion 614 of the return channel 610, but cannot completely enter the return channel 610 due to pressure build up, or “air-lock,” in the return channel 610 created by the blockage of the fluid at the exit portion 612.

When the optical bio-disc, including the fluidic circuit 600, is rotated, centrifugal forces cause the liquid 620 in the exit portion 612 of the return channel 610 to flow out of the exit portion 612, thereby unblocking the exit portion 612 and reducing or eliminating the air lock. When the air lock is reduced, the liquid 620 in the loading chamber 616 enters the return channel 610 through the entrance portion 614. As illustrated in FIG. 8C, which represents the state of the fluidic circuit 600 during centrifugation and is referred to as state [2]. In state [2], the liquid 620 fills the return channel 610 to a level that depends upon the strength of the centrifugal force and the amount of liquid 620 in the loading chamber 616. As illustrated in fluidic circuit FIG. 8D, which represents the state of the fluidic circuit 600 after centrifugation and is referred to as state [3]. In state [3], capillary forces draw the liquid 620 through the return channel 610, thus filling the return channel 610 with the liquid 620.

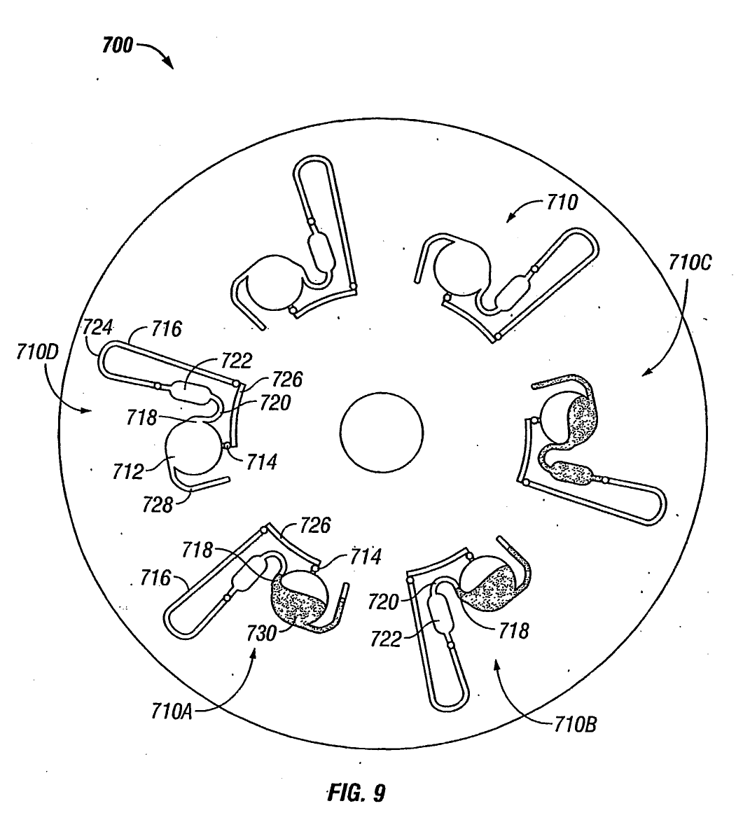

FIG. 9 is a top plan view of a bio-disc having fluidic circuits 710 configured to separate samples, wherein the fluidic circuits 710A, 710B, and 710C are in respective of the three states [1], [2], and [3], as described above. The exemplary fluidic circuits 710 include a loading chamber 712, an inlet port 714 configured to receive sample that is to be loaded into the loading chamber 712. The fluidic circuits 710 further include a return channel 716 that is in fluid communication with the loading chamber 712. In the embodiment of FIG. 9, the return channel 716 includes an entrance portion 718 that is in fluid communication with the loading chamber 712, an elbow section 720 that is in fluid communication with the entrance portion 718. In the embodiment of FIG. 9, the elbow section 720 opens into an analysis chamber 722 that is in fluid communication with a U-section 724, where the U-section is connected to an exit portion 726 of the return channel 716. In this embodiment, the exit portion 726 is in fluid communication with the loading chamber 712 and is located closer to the center of the optical bio-disc 700 than the entrance portion 718.

In the embodiment of FIG. 9, the inlet port 714 is advantageously located proximal to the exit portion 726 of the return channel 716 so that when fluid is loaded through the inlet port 714, some of the fluid enters the exit portion of the return channel, which thereby creates a fluid or liquid valve that prevents the fluid in the loading chamber 712 from entering the elbow section 720 of the return channel 716. The fluidic circuit 710 may optionally include a vent chamber 728 that is in fluid communication with the loading chamber 712, as shown in fluidic circuit 710D, which allows venting of air out of the loading chamber 712 to allow loading of the sample into the loading chamber 712.

In one embodiment, the fluidic circuit 710 may advantageously be used to separate and isolate serum from a whole blood sample. As noted above, fluidic circuits 710A, B, and C illustrate exemplary fluidic circuits that are in respective of the three states [1], [2], and [3] of a sample preparation process. In particular, the fluidic circuit 710A (state [1]) is illustrated with a sample 730, such as blood, loaded through the inlet port 714 into the loading chamber 712 where a part of the sample 730 enters the exit portion 726 of the loop. An “air lock” is created when the sample 730 comes in contact with the entry portion 718 and a part of the sample 730 enters the entry portion 718 of the return channel 716 since the exit portion 726 is essentially blocked by a part of the sample 730. The air lock thus prevents the sample from entering into the rest of the return channel 716. The blockage in the exit portion 726 is removed by rotating the disc, which eliminates the air lock and the cells in the blood sample are separated by rotating the disc further, as shown in the fluidic circuit 71013 (state [2]).

When the disc 710 is stopped, serum is drawn into the entrance portion 718, through the elbow section 720, and into the analysis chamber 722 of the return channel 716 by capillary forces as shown in the fluidic circuit 710C (state [3]). In the configuration illustrated in FIG. 9, the serum may be stopped by a capillary valve in the return channel 716, giving time for a reaction in the analysis chamber 722. A subsequent rotation will draw the reaction products into the rest of the return channel 716 for detection or further reaction.

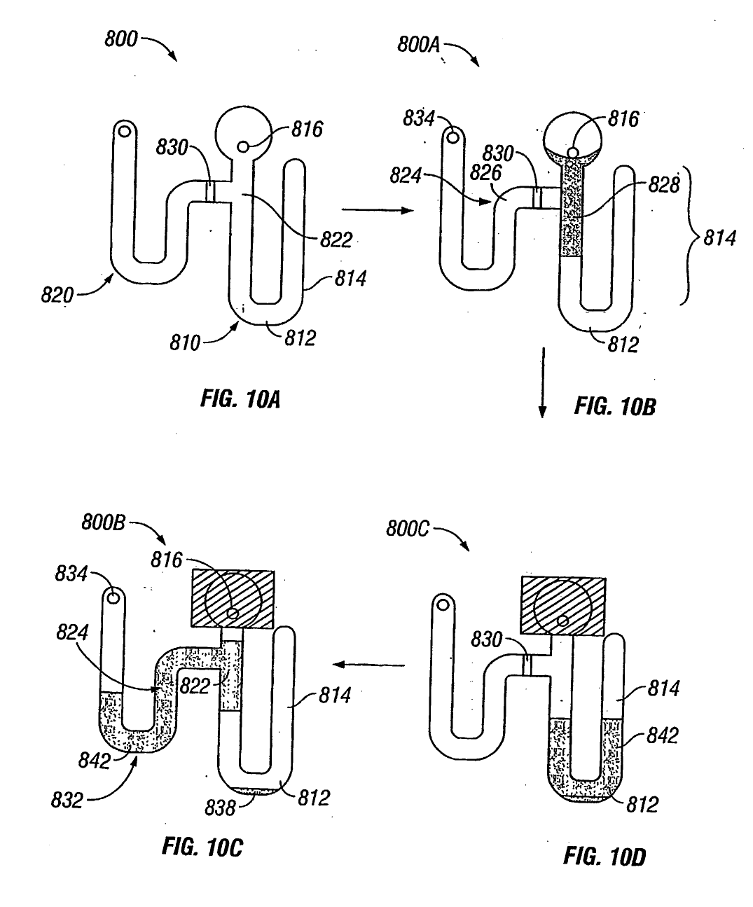

An alternative fluidic circuit and an associated method of achieving sample separation and isolation in conjunction with such a fluid circuit is to use a pneumatically driven sample separation and isolation fluidic circuit. An example of a pneumatically driven fluidic circuit is depicted in FIGS. 10A, 10B, 10C, and 10D, where a closed U-channel is used for the cell separation, and pressure built up during centrifugation leads the liquid to flow into a return channel (State [3]), along with normal surface tension forces. One motive force that may be utilized in the this embodiment of is a ‘piston’ of air (“High Pressure Air”) compressed within an air chamber.

FIGS. 10A, 10B, 10C, and 10D are each a top view of a fluidic circuit configured to be placed on a bio-disc, such as the bio-discs described with respect to the earlier Figures, wherein FIGS. 10B, 10C, and 10D are illustrative of steps in a pneumatically driven fluid separation system. Each of the fluidic circuits 800 includes two main channels, a first main channel 810 and a second main channel 820. The first main channel 810 includes a separation or loading chamber 812 in fluid communication with an air tight or sealed air chamber 814 and an inlet port 816 for loading samples into the loading chamber 812. The second main channel 820 is in fluid communication with the first main channel 810 through an entrance portion 822 connected to the separation chamber 812. In the embodiment of FIGS. 10A, 10B, 10C, and 10D, the connection between the entrance portion 822 and the separation chamber 812 is situated in the separation chamber so that a sample 828 is prevented from entering the return channel 824 prior to separating unwanted elements in the sample 828. An elbow section 826 may be connected to and in fluid communication with the entrance portion 822 to further prevent flow of the sample 828 into the return channel 824 and allow any pre-separated sample 828 to flow back into the separation chamber 812 during sample preparation. A portion of the elbow section 826 may also be coated or filled with a hydrophobic barrier or a filter element 830 to also prevent portions of the sample 828 from prematurely entering the return channel 824. The return channel 824 may further include a U-segment 832 in fluid communication with the elbow section 826. In one embodiment, the U-segment 832 opens to a vent port 834 and may include an analysis area or section having reagents deposited therein. In one embodiment, the reagents allow for detection and or quantitation of analytes present in the isolated sample 828.

The fluidic circuits 800A (FIG. 10B), 800B (FIG. 10C), and 800C (FIG. 10D) illustrate three stages of separation of components of a material, such as serum, from a sample, such as whole blood using the fluidic circuit 800. As illustrated in FIG. 10B, in state [1] (fluidic circuit 800A), a whole blood sample 828 may be loaded into the separation chamber 812 through the inlet port 816. The sample 828 may then flow into the separation chamber 812 and is prevented from entering the elbow section 826 by the hydrophobic barrier 830. As illustrated in FIG. 10C, in state [2] (fluidic circuit 800B), the inlet port 816 may then be sealed and the disc rotated at a pre-determined speed and time to allow separation of serum 842 from the cells 838 in the blood sample 828. During rotation, a portion of the serum 842 enters the air chamber 814, thus compressing the air inside the air chamber 814 and creating pressurized air within the air chamber 814. FIG. 10D illustrates fluidic circuit 800C in state [3], where rotation of the disc is stopped. In this state, the pressurized air in the air chamber 814 causes the: serum 842 in the separation chamber 812 to move into the entrance portion 822 of the return channel 824 through the filter or hydrophobic barrier 830 and into the U segment 832 of,the return channel 824. Since the inlet port 816 is sealed and the vent port 834 remains open, most of the serum 842 is directed into the return channel 824.

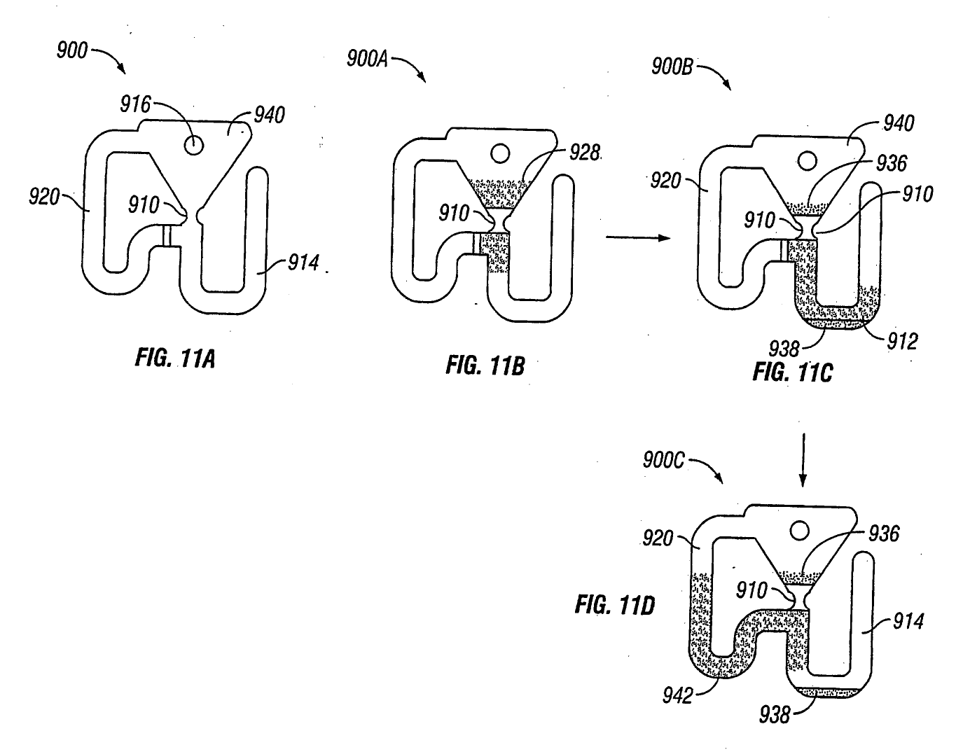

FIGS. 11A, 11B, 11C, and 11D are each a top view of a fluidic circuit configured to be placed on a bio-disc, such as the bio-discs described with respect to the earlier Figures. In this embodiment of FIGS. 11A, 11B, 11C, and 11C, the fluidic circuit 900 is configured such that a single port is used as an inlet and vent port 916. The fluidic circuit 900 includes many components of the circuit described in conjunction with FIG. 10 and further includes a sample separation portion 910 that may be a narrow channel configured to trap large particles from the sample, such as cells, and allow the liquid part of the sample (e.g., serum) to pass through. In the embodiment of FIGS. 11A, 11B, 11C, and 11D, fluidic circuit 900 includes an inlet and vent port 916, an air chamber 914, and a return channel. Fluidic circuits 900A (FIG. 11B), B (FIG. 11C), and C (FIG. 11D) illustrate three stages of separation of components of a sample, such as serum, from a sample, such as whole blood. In particular, as shown in FIG. 11B, fluidic circuit 900A is in state [1]. In this state, portions of the sample 928 may pass through the sample separation portion 910, which may include a filter or sieve. In one embodiment, the sample separation portion 910 prevents cells from passing through while allowing the serum to move past the sample separation portion 910. FIG. 11C illustrates fluidic circuit 900B in state [2], where centrifugation has begun. As illustrated in FIG. 11C, cells 936 accumulate, or pellet, at or around the separation portion 910, while plasma moves through the sample separation portion 910. In this embodiment cells 938 that do get through the sample separation portion 910 accumulate, or pellet, in the separation chamber 912. The cells 938 that pellet in or around the separation portion 912 essentially block back flow of fluid into the loading chamber 940. FIG. 11D illustrates fluidic circuit 900C in state [3] where centrifugation has stopped. As illustrated in FIG. 11D, a serum 942 is pneumatically directed into the return channel 920 by the high pressure air in the air chamber 914. Fluid does not enter the loading chamber 940 due to the blockage caused by the pellet of cells 936. As discussed above, the return channel 920 may be pre-loaded with reagents to allow detection and quantitation of analytes in the isolated sample.

The return channels described above and in conjunction with FIGS. 8A, 8B, 8D, 9, 10A, 10B, 10C, 10D, 11A, 11B, 11C, and 11D may be connected to and in fluid communication with one or more analysis chambers where aliquots of the isolated sample may be redirected or transferred to and analyzed for different targets or analytes. For example, a single sample of whole blood may be processed as described above. The isolated serum may then be directed into one or more analysis chambers from the return channel. In one embodiment, three analysis chambers, including a first analysis chamber having reagents for reverse typing, a second analysis, chamber having reagents for glucose quantitation, and a third analysis chamber having reagents for cholesterol analysis are included in a fluidic circuit. This set-up thus allows the analysis of three different analytes from a single sample. As will be apparent to one of skill in the art, multiple analytes may be detected and analyzed using the above-described systems and methods. Further details relating to blood typing using optical bio-discs are disclosed in, for example, U.S. patent application Ser. No. 10/298,263 entitled “Methods and Apparatus for Blood Typing with Optical Bio-Discs.”

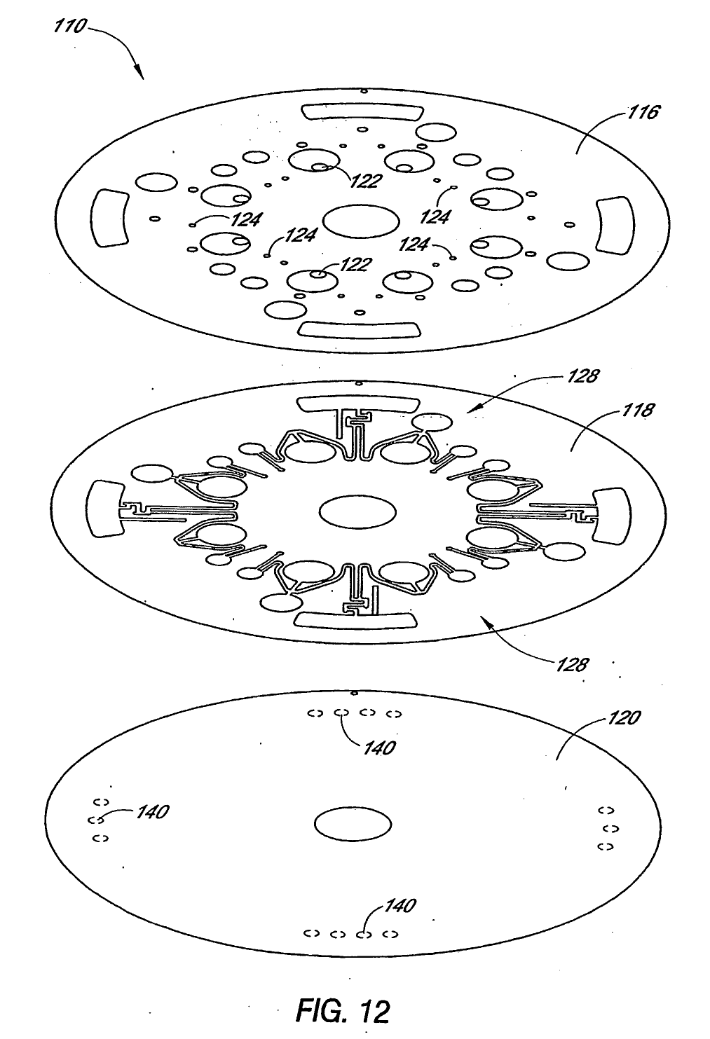

Referring now to FIG. 12, there is shown an exploded perspective view of certain structural elements of the optical bio-disc 110 having fluidic circuits 128 for sample preparation and analysis. The structural elements illustrated in FIG. 12 include the cap portion 116, the adhesive or channel member 118, and the substrate 120 layer. The exemplary cap portion 116 includes one or more inlet ports 122 and one or more vent ports 124. The cap portion 116 may optionally include portions of the fluidic circuits formed therein.

The exemplary adhesive or channel layer 118 includes fluidic circuits 128 formed therein. The fluidic circuits 128 are formed by stamping or cutting the membrane to remove a portion thereof and form the shapes as illustrated. The fluidic circuits 128 may include any of the fluidic circuits described above, for example, including those exemplary fluidic circuits described in FIGS. 8-11.

The exemplary substrate 120 may include target or capture zones 140. In one embodiment, the substrate 120 is made of polycarbonate and has a thin semi-reflective layer 143 (Not shown) deposited on the top thereof, which is illustrated and described above in conjunction with FIG. 6. In one embodiment, the semi-reflective layer 143 associated with the substrate 120 of the disc 110 is significantly thinner than the reflective layer 142 on the substrate 120 of the reflective disc 110 illustrated in FIGS. 2, 3 and 4. As discussed above, the thinner semi-reflective layer 143 allows for some transmission of the interrogation beam 152 through the structural layers of the transmissive disc, as shown in FIG. 5B, for example. The thin semi-reflective layer 143 may be formed from a metal such as aluminum or gold.

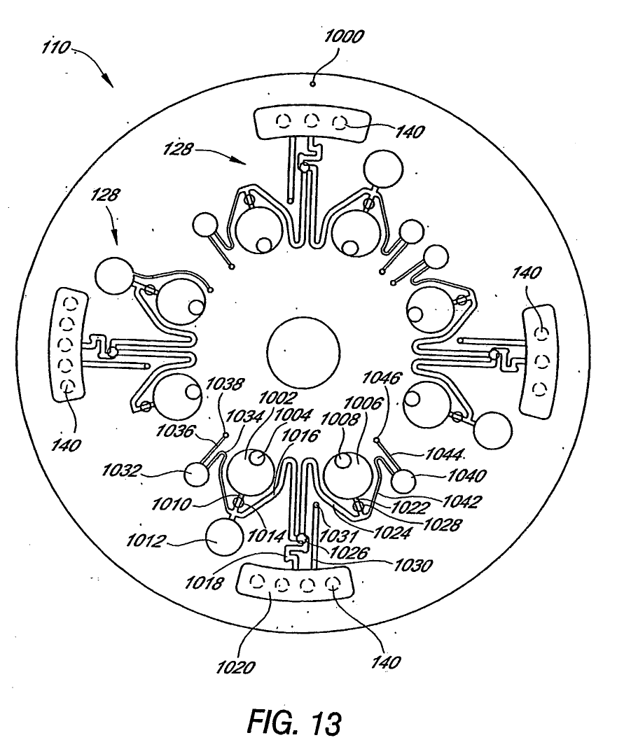

With reference next to FIG. 13, there is shown a top plan view of the transmissive type optical bio-disc 110 illustrated in FIG. 12. FIG. 13 depicts the transmissive type optical disc having the transparent cap portion 116 revealing different embodiments of the fluidic circuits or channels 128, an alignment hole 1000, and the target zones 140 as situated within the disc. In one embodiment, the alignment hole 1000 is used as a guide to place the various layers of the disc 110 in register with each other to form the fluidic circuit 128. Each of the fluidic circuits 128 may include a sample loading chamber 1002 having a sample inlet port 1004 opening. The circuit 128 also includes a buffer loading chamber 1006 having a buffer inlet port 1008 opening. The sample loading chamber 1002 is in fluid communication with a first end of a radially directed sample pass through channel 1010. The second end of the sample pass through channel 1010, located furthest from the center of the disc relative to the first end, is in fluid communication with a sample separation chamber 1012. The sample pass through channel 1010 may optionally include a first capillary valve 1014. Chamber 1012 is also in fluid communication with a first end of a sample flow channel 1016 which terminates into and is in fluid communication with a first end of a mixing chamber 1018. The second end of the mixing chamber 1018 is in fluid communication with an analysis chamber 1020 which may include one or more analysis, capture, or target zones 140.

In the exemplary embodiment of FIG. 13, the buffer loading chamber 1006 is connected to and in fluid communication with a first end of a buffer pass through channel 1022. The second end of channel 1022 is in fluid communication with a first end of a buffer flow channel 1024 which is also in fluid communication with the first end of the mixing channel 1018 at its second end. A second capillary valve 1026 may optionally be placed at the junction of the sample flow channel 1016, buffer flow channel 1024, and mixing channel 1018 as illustrated. A third capillary valve 1028 may optionally be placed in the buffer pass through channel 1022. Analysis chamber 1020 also includes a vent channel 1030 which opens into a vent port 124 that allows air from the analysis chamber to vent out to prevent air blockages within the fluidic circuit 128. Mixing channel 1018 may be configured as a zigzag or sawtooth channel or stepwise channel with sharp angled edges, corners or turns as opposed to smooth non-angled channels wherein fluid flow is continuous with little or no turbulence. In an advantageous embodiment, the mixing channels having angled edges enhances mixing of fluids in a fluidic circuit by creating turbulent flow. The path of mixing channel 1018 is defined, for example, by a step function or a sawtooth function depending on the angle of the corners. The angle of the corners may be 5 to 160 degrees, for example. As illustrated, fluid flow in the mixing channel is defined by a step function wherein the turns within the mixing channel are at about 90 degree angles.

Alternatively, the fluidic circuit 128, as illustrated in FIG. 13 may include waste chambers to hold excess sample and/or excess buffer. In an alternative embodiment, a fluidic circuit includes a sample waste chamber 1032 that is connected to the sample pass through chamber 1010 through a sample water channel 1032. Waste chamber 1032 also includes its own vent channel 1036 with a vent port 1038. In another alternate embodiment, the fluidic circuit 128 may include a buffer waste chamber 1040 connected to the buffer pass through channel 1022 at the junction of channel 1022 and the buffer flow channel 1024 by a buffer waste channel 1042. Waste chamber 1040 may also include a vent channel 1044 with a vent port opening 1046 to allow venting out of air in chamber 1040 to prevent air blockage in channel 1042 and chamber 1040.

The fluidic circuit illustrated and described in conjunction with FIGS. 12 and 13 may be used in assays requiring serum sample from a whole blood sample including, but not limited to reverse blood typing, glucose, cholesterol, LDH, myoglobin, triglycerides, GSH, TSH, HCG assays and various tumor marker assays.

To analyze blood serum for a specific analyte, for example, whole blood is loaded into the sample loading chamber 1002 through inlet port 1004. The blood is prevented from flowing into the rest of the fluidic circuit by the first capillary valve 1014. A dilution buffer may be loaded into the buffer loading chamber 1006 through inlet port 1008. The amount of buffer loaded into chamber 1006 depend upon the dilution factor required for the assay. Buffer is prevented from moving into the rest of the fluidic circuit by the third capillary valve 1028. After the sample and buffer are loaded, their respective inlet ports are sealed to prevent leaking of fluid out of the fluidic circuit. The disc is then loaded into the optical disc drive and rotated at a predetermined speed and time to allow movement of the blood from the loading chamber, through valve 1014 and into the separation chamber 1012. Consequently the buffer is also forced through valve 1028 thereby eliminating the capillary valve and allowing free movement of buffer through the circuit 128. The disc is further rotated to separate the serum from the blood cells. Once this is achieved, rotation is halted for a predetermined time to prime sample flow channel 1016 and buffer flow channel 1024 by allowing movement of buffer into flow channel 1024 and the separated serum to move from the separation chamber 1012 into flow channel 1016. An analysis software program may then be used to control the speed, acceleration, deceleration, ramping, and duration of the disc rotation. The buffer and serum are prevented from entering the mixing channel 1018 by valve 1026. Excess serum and buffer, if any, moves into their respective waste chambers 1032 and 1040 through their respective waste channels 1034 and 1042. After priming flow channels 1016 and 1024, the disc is rotated at another predetermined speed and for a predetermined time to allow fluid to move past valve 626 and into mixing chamber 618. The serum and buffer are mixed as they move through mixing chamber 618 thereby diluting the serum sample. The diluted serum sample moves into the analysis chamber 620 where it is tested for analytes of interest.

As discussed above, the analysis chamber may include analysis zones 140 having capture agents that bind analytes of interest present in the sample. Signal or reporter agents may also be preloaded into the analysis chamber 1020 that allows for the detection and quantitation of the analyte captured within the analysis zones 140. Reporter agents may include, for example, microspheres or nanospheres coated with a signal molecule such as a binding agent that specifically bind to the analyte of interest. Detection is carried out using the optical disc drive by directing and scanning the optical read beam 152 (FIG. 6) through the analysis zones and analyzing the return beam 154 or transmitted beam 156 (FIG. 6) to determine the presence and amount of signal agents present in the analysis zones. Analysis and quantitation of analytes may be carried out using an analysis software. Analysis of samples using capture agents and signal agents are disclosed in, for example, the above referenced, commonly assigned and co-pending U.S. patent applications Ser. No. 10/348,049 entitled “Multi-Purpose Optical Analysis Disc for Conducting Assays and Related Methods for Attaching Capture Agents”; Ser. No. 10/035,836 entitled “Surface Assembly for Immobilizing DNA Capture Probes and Bead-Based Assay Including Optical Bio-Discs and Methods Relating Thereto”; and Ser. No. 10/035,836 entitled “Surface Assembly for Immobilizing DNA Capture Probes and Bead-Based Assay Including Optical Bio-Discs and Methods Relating Thereto”.

Alternatively, the entire analysis chamber may be used as the analysis zone. In this embodiment, the analysis chamber may be preloaded with analysis reagents that react with a specific analyte in the diluted serum sample to produce a detectable signal such as a color change or color development. The resulting color developed in the process is preferably proportional to the amount of analyte in the sample. The analyte may then be quantified by scanning the read beam through the analysis chamber, detecting the return beam 154 or transmitted beam 156 (FIG. 6), and determining the amount of analyte based on the intensity of the return or transmitted beam. One or more calibration reference points may be used to accurately quantify the analyte by analyzing a reagent blank analysis chamber or a chamber having a known quantity of analyte. Further details relating to colorimetric assays using optical bio-discs is disclosed in, for example, commonly assigned co-pending U.S. Provisional Application Ser. No. 60/483,342 entitled “Fluidic Circuits, Methods and Apparatus for Use of Whole Blood Samples in Colorimetric Assays” filed on Jun. 27, 2003 which is incorporated by reference in its entirety as if fully repeated herein.

The fluid separation systems described above and illustrated in FIGS. 8-11 may be used for any assay requiring a serum sample such as reverse blood typing, glucose, cholesterol, LDL, myoglobin, LDH, various tumor marker assays, and other immunohematologic and genetic assays. Furthermore, the fluid separation system may be used isolate proteins in a homogenized tissue sample, oil or a hydrophobic layer in emulsion in organic extraction, supernatant from a microparticle suspension, any process requiring separation of fluids.

Concluding Statements

All patents, provisional applications, patent applications, and other publications mentioned in this specification are incorporated herein in their entireties by reference.

While this invention has been described in detail with reference to a certain preferred embodiments, it should be appreciated that the present invention is not limited to those precise embodiments. Rather, in view of the present disclosure that describes the current best mode for practicing the invention, many modifications and variations would present themselves to those of skill in the art without departing from the scope and spirit of this invention. The scope of the invention is, therefore, indicated by the following claims rather than by the foregoing description. All changes, modifications, and variations coming within the meaning and range of equivalency of the claims are to be considered within their scope.

Furthermore, those skilled in the art will recognize, or be able to ascertain, using no more than routine experimentation, many equivalents to the specific embodiments of the invention described herein. Such equivalents are also intended to be encompassed by the following claims.

What is claimed is:

1. A fluidic circuit for processing fluid, comprising:
a sample loading chamber for receiving an amount of fluid for processing, said sample loading chamber having a sample inlet port;
a sample pass through channel having a first end and a second end, said first end of said sample pass through channel in fluid communication with said sample loading chamber;
a separation chamber in fluid communication with said second end of said sample pass through channel;
a sample flow channel having a first and a second end, said first end of said sample flow channel in fluid communication with said sample pass through channel; and
an analysis chamber in fluid communication with said second end of said sample flow channel.

2. A fluidic circuit for processing fluid, comprising:
a sample loading chamber for receiving an amount of fluid for processing, said sample loading chamber including a sample inlet port;
a sample pass through channel having a first end and a second end, said first end of said sample pass through channel in fluid communication with said sample loading chamber;
a separation chamber in fluid communication with said second end of said sample pass through channel;
a sample flow channel having a first and a second end, said first end of said sample flow channel in fluid communication with said sample pass through channel;
a mixing chamber having a first end and a second end, said first end of said mixing chamber in fluid communication with said second end of said sample flow channel; and
an analysis chamber in fluid communication with said second end of said mixing chamber.

3. The fluidic circuit according to claim 2 further comprising:
a vent channel having a first end and a second end, said first and of said vent channel in fluid communication with said analysis chamber; and
a vent port in fluid communication with said second end of said vent channel.

4. The fluidic circuit according to claim 3 further comprising:
a buffer loading chamber for receiving an amount of fluid, said buffer loading chamber including a buffer inlet port;
a buffer pass through channel having a first end and a second end, said first end of said buffer pass through channel in fluid communication with said buffer loading chamber; and
a buffer flow channel having a first and a second end, said first end of said sample flow channel in fluid communication with said second end of said buffer pass through channel, said second end of said buffer flow channel in fluid communication with said first end of said mixing chamber.

5. The fluidic circuit according to claim 4 further comprising:
a sample waste channel having a first end and a second end, said first end of said sample waste channel connected to and in fluid communication with said sample pass through channel;
a sample waste chamber in fluid communication with said second end of said sample waste channel;
a sample waste vent channel in fluid communication with said sample waste chamber; and
a sample vent port in fluid communication with said sample vent channel.

6. The fluidic circuit according to claim 4 further comprising:
a buffer waste channel having a first end and a second end, said first end of said buffer waste channel connected to and in fluid communication with said buffer pass through channel;
a buffer waste chamber in fluid communication with said second end of said buffer waste channel; and
a buffer waste vent channel in fluid communication with said buffer waste chamber; and
a buffer vent port in fluid communication with said buffer vent channel.

7. The fluidic circuit according to claim 4 further comprising:
a sample waste vent channel in fluid communication with said separation chamber; and
a sample vent port in fluid communication with said sample waste vent channel.

8. The fluidic circuit according to claim 7 further comprising a first capillary valve within said sample pass through channel.

9. The fluidic circuit according to claim 7 further comprising a second capillary valve at the junction of said second end of said sample flow channel and first end of said mixing chamber.

10. The fluidic circuit according to claim 7 further comprising a third capillary valve within said buffer pass through channel.
